(19) United States
(12) Patent Application Publication
(10) Pub. No.: US 2023/0085415 A1
(43) Pub. Date: Mar. 16, 2023

(54) NEBULIZER SYSTEM FOR A MOTOR VEHICLE

(71) Applicant: VALEO SYSTEMES THERMIQUES, La Verriere (FR)

(72) Inventors: Clement ESCULIER, La Verriere (FR); Yves ROUSSEAU, La Verriere (FR); Vincent FEUILLARD, La Verriere (FR); Julien MIKHEL, La Verriere (FR)

(73) Assignee: VALEO SYSTEMES THERMIQUES, La Verriere (FR)

(21) Appl. No.: 17/796,012

(22) PCT Filed: Jan. 28, 2021
(86) PCT No.: PCT/FR2021/050154

§ 371 Date: Jul. 28, 2022

(30) Foreign Application Priority Data
Jan. 29, 2020 (FR) FR2000859

(51) Int. Cl. B05B 17/06; B60H 3/02; B60H 3/00

(52) U.S. Cl. CPC B05B 17/0615; B60H 3/022; B05B 17/0676; B60H 3/0092

(57) ABSTRACT

The invention relates to a nebulizer system for a motor vehicle, which is arranged to be fluidly connected to a liquid storage reservoir, which is called a cartridge, the nebulizer system including: a tank, a nebulizer component producing a mist intended to penetrate a passenger compartment of the motor vehicle, a channel for circulation of the liquid from the cartridge to the tank, and a channel for circulation of air between the cartridge and the nebulizer system.

### CROSS-REFERENCE TO RELATED APPLICATIONS

This application is filed under 35 U.S.C. §371 U.S. National Phase of International Application No. PCT/FR2021/050154 filed Jan. 28, 2021 (published as WO2021152259), which claims priority benefit to French application No. 2000859 filed on Jan. 29, 2020, the disclosures of which are herein incorporated by reference in their entirety.

### TECHNICAL FIELD

The subject of the invention is a nebulizer system for a motor vehicle.

### BACKGROUND OF THE INVENTION

In a known manner, a nebulizer system comprises a reservoir of liquid water and a device for emitting acoustic waves configured such that the water coming from the reservoir forms a mist of water droplets.

Such a nebulizer system makes it possible to cool an air flow in which the mist of water

is sprayed.

In a motor vehicle, even one provided with a ventilation and/or air-conditioning device, it is not uncommon for the users of the vehicle to suffer under heat in the vehicle interior, in particular the rear seat passengers, who are farther away from the air vents of the ventilation and/or air-conditioning device.

Thus, it is advantageous to make use of a nebulizer system, since the mist of water rapidly cools the air in the vehicle interior, providing a sensation of immediate cold while still rehumidifying it.

In general, the system comprises an electric pump dedicated to the flow of the liquid in the system while the system is operating.

However, the presence of the pump makes the arrangement of the system more complex and increases its size, while also increasing the energy consumption of the vehicle, this contradicting the current environmental preservation efforts undertaken by the automotive world.

Another drawback is that, since such a system contains water, the level of the liquid must be controlled in order to avoid any overflow out of the system, which could not only prove unpleasant for the owner of the vehicle, but in particular be dangerous given the number of electrical elements with which any vehicle is equipped.

The aim of the invention is to overcome this drawback.

### BRIEF SUMMARY OF THE INVENTION

To that end, the subject of the invention is a nebulizer system for a motor vehicle, arranged so as to be fluidically connected to a liquid storage reservoir, referred to as cartridge, the nebulizer system comprising a reservoir for storing the liquid coming from the cartridge, referred to as tank, a nebulizing component provided with a device for emitting acoustic waves configured such that said liquid forms a mist of droplets of said liquid, the mist being intended to enter an interior of the motor vehicle, the nebulizing component being arranged, in the operating position of the system, at a position defined by a level given along three orthogonal axes in pairs, a first axis corresponding to a direction of forward travel of the motor vehicle, a second axis corresponding to a transverse direction of the vehicle and a third axis corresponding to a vertical direction, a channel for circulating the liquid coming from said cartridge to the tank, said liquid circulation channel extending between a first end, referred to as cartridge end, of the channel for circulating the liquid coming from said cartridge, and a second end, referred to as system end, of the channel for circulating the liquid coming from said cartridge, and a channel for circulating air between said cartridge and the nebulizer system, said air circulation channel extending between a first end, referred to as first cartridge end, of the channel for circulating air between said cartridge and the nebulizer system, and a second end, referred to as system end, of the channel for circulating air between said cartridge and the nebulizer system.

In this way, the flow of both the liquid and the water supplies the system with liquid without it being necessary to equip it with a pump.

According to another aspect, in the operating position of the system, the system end of the channel for circulating air between said cartridge and the nebulizer system is disposed at the same level in the third direction, referred to as vertical level, as the nebulizing component.

According to another aspect, in the operating position of the system, the system end of the channel for circulating air between said cartridge and the nebulizer system is disposed at the same level in the first direction, referred to as longitudinal level, as the nebulizing component.

According to another aspect, in the operating position of the system, the system end of the channel for circulating air between said cartridge and the nebulizer system is offset with respect to the level of the nebulizing component in the second direction, referred to as transverse level.

According to another aspect, in the operating position, a portion of the channel for circulating air between said cartridge and the nebulizer system bearing the first system end of the air circulation channel forms an angle of between 0° and 30° with a horizontal plane.

According to another aspect, the channel for circulating air between said cartridge and the nebulizer system and the channel for circulating liquid coming from said cartridge are separate from one another.

According to another aspect, the system end of the liquid circulation channel for the liquid coming from said cartridge is disposed in a base of the tank.

According to another aspect, the channel for circulating air between said cartridge and the nebulizer system and the liquid circulation channel for the liquid coming from said cartridge are coincident.

According to another aspect, the system comprises an electroluminescent device configured to emit radiation in the ultraviolet C spectrum and oriented in the nebulizer system so as to irradiate the liquid circulating in the tank, at least a part at least of the electroluminescent device being submerged in the tank, in the operating position of the nebulizer system.

Another subject of the invention is an assembly of a nebulizer system as described above and a liquid storage reservoir, referred to as cartridge, which are arranged so as to be fluidically connected to one another by the liquid circulation channel of the nebulizer system and the air circulation channel of the nebulizer system.

### BRIEF DESCRIPTION OF THE DRAWINGS

Other features, details and advantages of the invention will become apparent upon reading the detailed description below, and upon analyzing the appended drawings, in which:

FIG. 1 illustrates a schematic cross-sectional view of a nebulizer system according to the present invention,

FIG. 2 illustrates a schematic view of the system of FIG. 1 in another cross section,

FIG. 3 illustrates a schematic view of the system of FIG. 1 in section through a horizontal plane, and

FIG. 4 illustrates a schematic view of the system of FIG. 3, showing specific positioning zones for an air circulation channel.

### DETAILED DESCRIPTION OF THE INVENTION

The figures illustrate a nebulizer system in a position similar to its operating position, that is to say the position that it occupies when it is installed in a motor vehicle.

A reference system (X, Y, Z) has been shown for this purpose. The direction X corresponds to a longitudinal direction of forward travel of the motor vehicle. The transverse direction Y is defined as being perpendicular to the longitudinal direction X. More specifically, the longitudinal and transverse directions X and Y can for example belong substantially to a substantially horizontal plane. The direction Z for its part corresponds to a vertical direction.

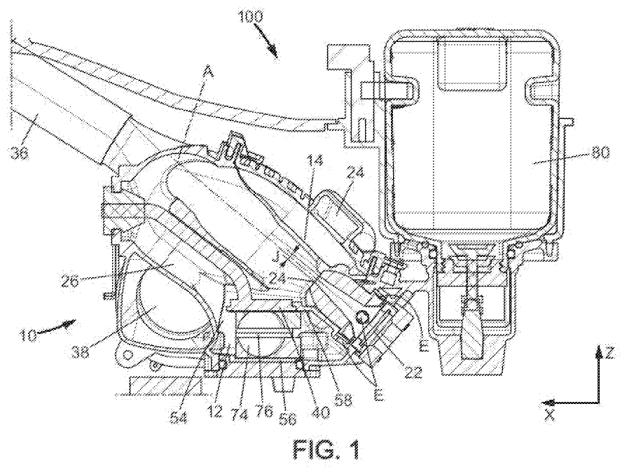

A subject of the invention is a nebulizer system 10 for a motor vehicle, shown in FIGS. 1 to 4.

The nebulizer system 10 makes it possible to cool an air flow intended for the interior of the motor vehicle, as will be described in more detail. The nebulizer system 10 is, for example, intended to be incorporated in a central console arranged in the interior of the motor vehicle.

As can be seen in the figures, the nebulizer system 10 comprises a reservoir for storing a liquid fluid, preferably liquid water, that is set out below, otherwise referred to as tank 12.

The nebulizer system 10 is arranged so as to be fluidically connected to another liquid storage reservoir, referred to below as cartridge 80, as will be described in more detail later on.

The nebulizer system 10 preferably comprises a nebulizer enclosure 14, illustrated in FIG. 1. Here, the nebulizer enclosure 14 is realized in the form of an elongate hollow body extending along a longitudinal axis A.

As can be seen in FIG. 1, the longitudinal axis A is inclined with respect to a vertical direction Z and with respect to a horizontal direction X.

As is also apparent from the figures, the nebulizer system 10 has a nebulizing component having, in this exemplary embodiment, a nebulizer nozzle 20 provided with a device for emitting acoustic waves transmitted into the liquid, which device is configured such that the surface of the liquid coming from the nozzle 20 generates a mist of droplets of the liquid, this mist being intended to enter an interior of the motor vehicle.

It will be noted that the longitudinal axis A also corresponds to the direction in which the jet J of water from which the mist detaches is ejected from the nebulizer nozzle 20 into a nebulizer chamber.

The nebulizer nozzle 20 is arranged at least partially inside the nebulizer enclosure 14. The nebulizer nozzle 20 has a lateral wall delimiting an interior volume which is able to contain the liquid to be nebulized and is shaped so as to implement an acoustic wave concentrator. A piezoelectric (ceramic) element 22 is arranged on the opposite side to an outlet orifice 24 for the liquid.

The piezoelectric element 22 is able to emit acoustic waves into the liquid to be sprayed, thereby making it possible to generate a mist of liquid droplets when the nebulizer nozzle 20 is filled by the latter and when the piezoelectric element 22 emits acoustic waves of a suitable frequency and intensity. The piezoelectric element 22 will preferably be able to emit ultrasound at a frequency of between 1 MHz and 3 MHz, in particular between 1.7 MHz and 2.4 MHz.

For example, the diameter of the droplets present in the mist is less than 10 μm.

As can be seen in FIG. 1, the nebulizer nozzle 20 also has at least one intake orifice E which allows the introduction of the liquid to be nebulized into the interior volume of the nebulizer nozzle 20, in fluidic communication with the reservoir 12.

The positioning of the outlet orifice 24 of the nebulizer nozzle 20 is positioned at a coordinate x0 in the direction X, referred to as longitudinal level, at a coordinate y0 in the direction Y, referred to as transverse level, and at a coordinate z0 in the direction Z, referred to as vertical level.

As can be seen in the figures, the nebulizer system 10 also comprises a return duct 26 for returning the liquid to the reservoir 12 which extends the nebulizer enclosure 14 with formation of an almost 180° curve. The curved shape of the return duct 26 ensures improved compactness of the nebulizer system 10.

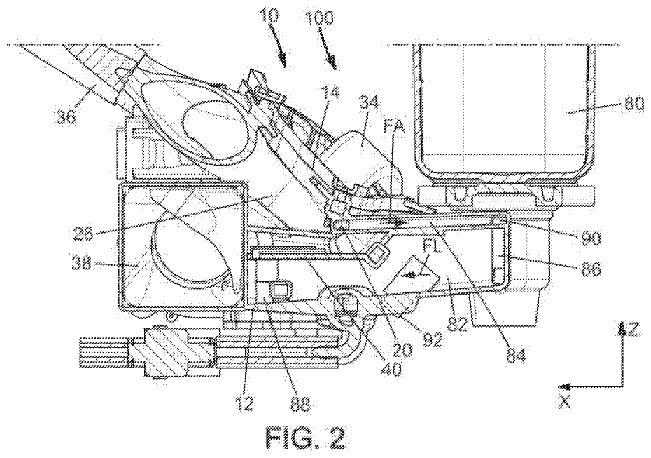

As can be seen in particular in FIGS. 1 and 2, the nebulizer system 10 further has an air inlet duct 34 and also at least one outlet duct 36 for discharging the mist toward the interior of the vehicle, and a fan 38 forcing the movement of the air.

Thus, the air enters the nebulizer enclosure 14 where the air and the nebulized liquid mix before the mixture leaves the system 10 via the outlet duct 36 for the mist, where it circulates to the interior of the vehicle.

The nebulizer system 10 also comprises an electroluminescent device 40.

The electroluminescent device 40 has an ultraviolet radiation source with emitted wavelengths within the ultraviolet C spectrum, between 200 nm and 280 nm. The ultraviolet C radiation makes it possible, in a known manner, to kill bacteria. Advantageously, the electroluminescent device 40 consists of a photolysis reactor with light-emitting diode(s).

In the operating position, the electroluminescent device 40 is submerged, thereby ensuring that it is effectively cooled and ensuring the safety of the users of the vehicle, due to the weak propagation of ultraviolet C radiation in the water.

As can be seen from the figures, the tank 12 comprises a portion, referred to as intermediate portion 54, arranged between the return duct 26 and the nebulizer nozzle 20.

The intermediate portion 54 comprises a planar base wall 56 and an upper wall 58 arranged above the base wall 56 so as to force the water to pass between the electroluminescent device 40 and the nebulizer nozzle 20.

As can be seen in FIG. 1, the intermediate portion 54 is provided with a sphere 74, preferably made of white Teflon (which has a UV reflection coefficient of 97%), provided with a passage channel 76 for water passing through the center of the sphere 74. The sphere 74 ensures convergence of the ultraviolet rays toward the center of the sphere, thereby improving the irradiation power of the electroluminescent device 40. The ultraviolet radiation source is arranged on the sphere 74 and oriented toward the passage channel 76 for water to pass through, such that the water circulating in the passage channel 76 is irradiated as it traverses the sphere 74. The sphere 74 also makes it possible to improve the safety of the nebulizer system 10 by way of its confinement of ultraviolet C rays.

As can be seen in FIG. 1, the upper wall 58 extends from the sphere 74, and then around the nebulizer nozzle 20 to beyond the nebulizer nozzle 20, thereby ensuring that the water is conveyed from the passage channel 76 for water to pass through to the inlet orifice E of the nebulizer nozzle 20, while still forcing the water to traverse the passage channel 76 before arriving at the nebulizer nozzle 20. In other words, this configuration forms a duct for conveying the water to the nebulizer nozzle 20 which ensures that all the water present in the nebulizer system 10 is treated by the ultraviolet radiation.

As already indicated, the nebulizer system 10 is fluidically connected to a cartridge 80.

As can be seen in FIG. 2, the system 10 comprises a liquid circulation channel 82 for circulating the liquid coming from the cartridge 80 to the tank 12. The system 10 also comprises an air circulation channel 84 for circulating air between the cartridge 80 and the system 10.

The liquid circulation channel 82 extends between a first end, referred to as cartridge liquid end 86, of the liquid circulation channel 82 and a second end, referred to as system liquid end 88, of the liquid circulation channel 82. In other words, the air liquid circulation channel 82 extends between the cartridge 80 and the nebulizer system 10.

The air circulation channel 84 extends between a first end, referred to as cartridge air end 90, of the air circulation channel 84 and a second end, referred to as system air end 92, of the air circulation channel 84. In other words, the air circulation channel 84 extends between the cartridge 80 and the nebulizer system 10.

As also illustrated in FIG. 2, the cartridge liquid end 86 of the liquid circulation channel 82 is disposed in the cartridge 80. The system liquid end 88 of the liquid circulation channel 82 is disposed at the intermediate part 54.

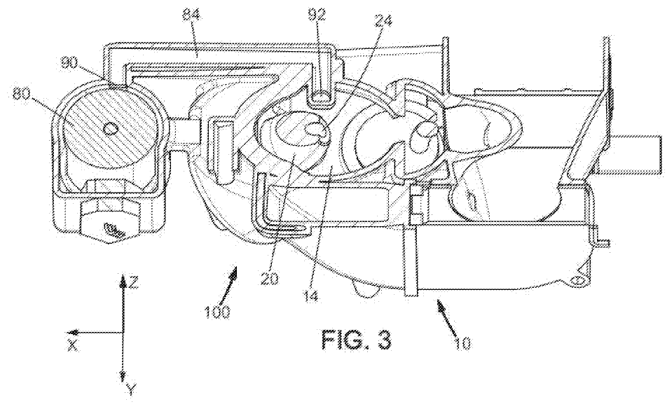

As can also be seen in FIGS. 2 and 3, the cartridge air end 90 of the air circulation channel 84 is disposed in the cartridge 80, above the cartridge liquid end 86 of the liquid circulation channel 82. The system air end 92 of the air circulation channel 84 is disposed in the nebulizer enclosure 14, as will be described in more detail.

The liquid circulation channel 82 and the air circulation channel 84 extend substantially horizontally. However, they can also be inclined, with the slope of the liquid circulation channel 82 being positive between the system liquid end 88 and the cartridge liquid end 86, in order to allow the water to flow from the cartridge 80 to the tank 12.

This arrangement makes it possible to avoid using a pump for circulating the water in the nebulizer system 10.

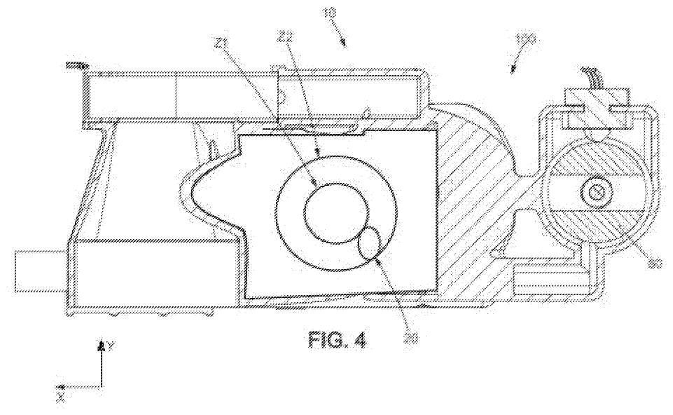

With reference to FIGS. 3 and 4, the positioning of the system air end 92 of the air circulation channel 84 will now be described in detail.

As is apparent from these figures, the system air end 92 is positioned at the same vertical level (same coordinate z0) as the outlet orifice 24 of the nebulizer nozzle 20, thereby making it possible to ensure that the maximum level of liquid in the nebulizer system 10 does not flood the outlet of the nebulizer nozzle 20, as will be explained later on.

As can be seen in FIG. 3, the system air end 92 is preferably positioned at the same longitudinal level (same coordinate x0) as the outlet orifice 24 of the nebulizer nozzle 20, thereby making it possible to ensure that the level of water at the system air end 92 is substantially the same as at the outlet orifice 24 of the nebulizer nozzle 20.

The system air end 92 and/or the outlet orifice 24 of the nebulizer nozzle 20 are/is preferably located in a zone with a constant level of water regardless of the accelerations (forward, backward, left, right) to which the vehicle is subjected.

The system air end 92 is offset with respect to the transverse level (coordinate y0) of the outlet orifice 24 in order not to disrupt the operation of the nebulizer nozzle 20 and in particular not to block the jet J. The offset is for example 0.5 mm to 10 cm, in particular 1 cm to 5 cm.

In FIG. 4, there can be seen a first zone Z1 corresponding to the acceptable zone for positioning the system air end 92 of the air circulation channel 84. There can also be seen a less extensive second zone Z2, corresponding to the preferential zone for positioning the system air end 92.

In the zone Z1, the system air end 92 is advantageously positioned at an angle of between 0° and 10° with respect to a plane (X, Y). In the zone Z2, the system air end 92 is advantageously positioned at an angle of between 0° and 30° with respect to this same plane, preferably between 0° and 20°.

The zones, in particular their shape and their dimensions, depend on the shape of the surface of the water, a surface which can vary depending on the inclination of the tank. The center of the zone, the “barycenter”, is the point which will be able to tolerate adjustment to the maximum angles imposed on the container (30° for example). The larger the zone to be considered, the smaller the maximum angle tolerated for the adjustment.

Another subject of the invention is an assembly 100 of the nebulizer system 10 and the cartridge 80. The cartridge 80 is mounted removably integrally with the nebulizer system 10, in a fluidic relationship with the nebulizer system 10 via the liquid and air circulation channels 82 and 84.

Once it has been installed, the cartridge 80 supplies liquid to the nebulizer system 10, up to a level chosen so that the water submerges a part of the nebulizer enclosure 14, as far as the outlet orifice 24 of the nebulizer nozzle 20, and also a part of the intermediate portion 54. In particular, the electroluminescent device 40 is submerged.

When the nebulizer system 10 is in operation, the level of water gradually drops, since the mist of droplets is evacuated into the vehicle interior, and a flow of air FA moves in the air circulation channel 84 from the system air end 92 to the cartridge 80, whereas a flow of liquid FL flows in the liquid circulation channel 82 from the cartridge end 86 to the tank 12. Thus, the two fluids (liquid and water) move in opposite directions in their respective channel.

The nebulizer system 10 refills itself until the level of water reaches the system air end 92 of the air circulation channel 84. Then, the air in the nebulizer enclosure 14 can no longer communicate with the cartridge 80, thereby also preventing the movement of liquid in the liquid circulation channel 82. Therefore, the maximum vertical level of water is controlled by the vertical positioning of the system air end 92 of the air circulation channel 84.

Of course, the invention is not limited to the embodiment illustrated. In particular, in the illustrated embodiment, the liquid circulation channel 82 and the air circulation channel 84 are separate from one another. However, it is possible to envisage a single duct for forming the air circulation channel and the liquid circulation channel, in particular if the diameter of the duct is sufficient, for example greater than 3 mm.

The nebulizer system 10 according to the present invention supplies liquid to the nebulizer nozzle 20 without a pump, by virtue of the bidirectional circulation of the liquid and the air. Furthermore, the level of liquid in the system is controlled reliably and easily, by way of the positioning of the system air end 92 of the air circulation channel 84. Lastly, the submersion of the electroluminescent device 40 ensures antibacterial treatment of the liquid in complete safety.

What is claimed is:

1. A nebulizer system for a motor vehicle, arranged so as to be fluidically connected to a cartridge for storing liquid, the nebulizer system comprising:
a tank for storing the liquid coming from the cartridge,
a nebulizing component provided with a device for emitting acoustic waves configured such that said liquid forms a mist of droplets of said liquid, the mist being intended to enter an interior of the motor vehicle, the nebulizing component being arranged, in the operating position of the system, at a position defined by a level given along three orthogonal axes in pairs, a first axis corresponding to a direction of forward travel of the motor vehicle, a second axis corresponding to a transverse direction of the vehicle and a third axis corresponding to a vertical direction,
a liquid circulation channel for circulating the liquid coming from said cartridge to the tank, said liquid circulation channel extending between a cartridge liquid end and a nebulizer system liquid end, and
an air circulation channel for circulating air between said cartridge and the nebulizer system, said air circulation channel extending between a cartridge air end a nebulizer.

2. The nebulizer system as claimed in claim 1, wherein, in the operating position of the system, the nebulizer system air end is disposed at the same level long the third axis as the nebulizing component.

3. The nebulizer system as claimed in claim 1, wherein, in the operating position of the system, the nebulizer system air end is disposed at the same level along the first axis as the nebulizing component.

4. The nebulizer system as claimed in claim 1, wherein, in the operating position of the system, the system air end is offset with respect to the level of the nebulizing component in the second axis.

5. The nebulizer system as claimed in claim 1, wherein, in the operating position, a portion of the air circulation channel bearing the cartridge air end forms an angle of between 0° and 30° with a horizontal plane defined by the first axis and the second axis.

6. The nebulizer system as claimed in claim 1, wherein the air circulation channel and the liquid circulation channel are separate from one another.

7. The nebulizer system as claimed in claim 1, wherein the system liquid end is disposed in a base of the tank.

8. The nebulizer system as claimed in claim 1, wherein the air circulation channel and the liquid circulation channel formed in a single duct.

9. The nebulizer system as claimed in claim 1, including an electroluminescent device configured to emit radiation in the ultraviolet C spectrum and oriented in the nebulizer system so as to irradiate the liquid circulating in the tank, at least a part of the electroluminescent device being submerged in the tank in the operating position of the nebulizer system.

10. An assembly including
a nebulizer system for a motor vehicle, arranged so as to be fluidically connected to a cartridge for storing liquid, the nebulizer system including:
a tank for storing the liquid coming from the cartridge,
a nebulizing component provided with a device for emitting acoustic waves configured such that said liquid forms a mist of droplets of said liquid, the mist being intended to enter an interior of the motor vehicle, the nebulizing component being arranged, in the operating position of the system, at a position defined by a level given along three orthogonal axes in pairs, a first axis corresponding to a direction of forward travel of the motor vehicle, a second axis corresponding to a transverse direction of the vehicle and a third axis corresponding to a vertical direction,
a liquid circulation channel for circulating the liquid coming from said cartridge to the tank, said liquid circulation channel extending between a cartridge liquid end and a nebulizer system liquid end, and
an air circulation channel for circulating air between said cartridge and the nebulizer system, said air circulation channel extending between a cartridge air end and a nebulizer system air end; and
a cartridge for storing the liquid,
which are arranged so as to be fluidically connected to one another by the liquid circulation channel of the nebulizer system and the air circulation channel of the nebulizer system.
